(19) United States
(12) Patent Application Publication
(10) Pub. No.: US 2026/0283184 A1
(43) Pub. Date: Sep. 24, 2026

(54) SYSTEMS AND METHODS FOR MANUFACTURING IMPROVED GUMMY SUPPLEMENT COATING

(71) Applicant: MeriCal, LLC, Anaheim, CA (US)

(72) Inventors: Haiyan Ge, Valencia, CA (US); Jeremy Bartos, San Marcos, CA (US); Mark Burcin, Escondido, CA (US); Bret Lewis, Nibley, UT (US)

(73) Assignee: MeriCal, LLC, Anaheim, CA (US)

(21) Appl. No.: 19/570,393

(22) Filed: Mar. 18, 2026

Related U.S. Application Data
(60) Provisional application No. 63/773,805, filed on Mar. 18, 2025.

(51) Int. Cl. A23G 3/48; A23G 3/34; A23G 3/36; A23G 3/42; A23G 3/50; A23L 29/231

(52) U.S. Cl. CPC A23G 3/48; A23G 3/0078; A23G 3/0085; A23G 3/362; A23G 3/42; A23G 3/50; A23L 29/231

(57) ABSTRACT

A gummy supplement is provided. The gummy supplement includes a mixture of sugar and/or a sugar alternative, a gelling component, an active component, color, flavor, and acid. The amount of the gelling component is sufficient to result in a formed gelled product after the mixture is cooked and cured. The gummy supplement further comprises a coating for the formed gelled product comprising bamboo fiber.

### CROSS-REFERENCE TO RELATED PATENT APPLICATION

The present application claims the benefit of U.S. Provisional Application Ser. No. 63/773,805, filed Mar. 18, 2025, which is incorporated by reference herein in its entirety.

### FIELD

The present application relates to gummy compositions, and more specifically to an improved coating for gummy supplements and the manufacture thereof.

### BACKGROUND

Traditionally, gummy candies and supplements have been manufactured and then deposited using equipment known as a starch mogul. The starch mogul includes trays filled with starch, each of which has a mold firmly pressed into it to form cavities in the starch. The cavities are then filled with a heated gummy composition, often containing pectin or gelatin as a structuring agent for the gummy, sugar and syrup as the sweetener and bulking agent, and the gummy is permitted to cool and harden as needed. The starch helps to reduce the temperature of the gummy composition and to absorb water from the gummy composition. Both help the gummy composition to solidify. After cooling, the gummies are removed from the starch trays, cleaned of any starch residue, and coated with an anti-sticking agent in an oiling drum. The anti-sticking agent provides the gummies with a glossy appearance and minimizes stickiness of the gummies after packaging.

The starch used in a mogul process can be heated, dried, and re-used for subsequent batches of gummies. However, such recycling can raise the risk of cross-contamination as the starch draws water from the gummies during the cooling process and other substances can potentially migrate with the water into the starch powders at the gummy surfaces. The risk of cross-contamination is particularly problematic when the gummy product is a supplement and contains one or more bioactive ingredients (e.g., vitamins, minerals, amino acids, antioxidants, herbal compositions, active pharmaceutical ingredient (API) compositions) that require stringent hygienic standards.

Manufacturers of gummy supplements are therefore increasingly turning to starchless manufacturing methods. Starchless manufacturing methods may alternatively utilize silicone, rubber, metal, or polycarbonate molds to provide the formed gummy shapes. Such molds must be coated with an anti-sticking agent to facilitate removal of the gummy supplements from the molds. Additional anti-sticking agent may be applied to the formed gummy supplements to prevent sticking inside packaging. Tapioca starch is presently used in starchless gummy manufacturing as an anti-sticking agent, but it exhibits mediocre performance as gummy supplements coated with tapioca starch often begin to stick to each other and to packaging within one to two weeks after packaging. Sugar sanding is an alternative to the use of tapioca starch and exhibits improved performance in preventing sticking of gummy supplements to each other and to packaging; however, many consumers are concerned with their sugar intake and do not wish to increase their sugar intake due to consumption of a gummy supplement coated with sugar. Citrus fiber and other starches such as potato starch have been considered as alternatives to tapioca starch and sugar, however these ingredients can have a noticeable aftertaste that may not be palatable to consumers. Such ingredients may also introduce microbiological contaminants into gummy supplements.

### SUMMARY

According to an exemplary implementation of the present disclosure, a gummy supplement is provided. The gummy supplement includes a mixture of sugar or sugar alternatives, a gelling component, an active component, flavoring, coloring and an acid. The amount of the gelling component is sufficient to result in a formed gelled product after the mixture is cooked and cured. The gummy supplement further comprises a coating for the formed gelled product comprising bamboo fiber and other fibers such as microcrystalline cellulose.

The active component in the gummy supplement may include, but is not limited to, a vitamin composition, a mineral composition, an amino acid composition, an antioxidant composition, an herbal composition, a probiotic and/or postbiotic composition, and an active pharmaceutical ingredient (API) composition or variations containing one or more of the above. In various embodiments, the gummy supplement could be molded into a smooth contoured (e.g. a gumdrop) or irregularly contoured (e.g. a raspberry) shape by a forming structure.

The bamboo fiber functions as an anti-sticking agent and is preferably in powder form. In a preferred embodiment, the bamboo fiber ranges from 0.2% to 1.5% by weight of the total gummy weight. In another preferred embodiment, the bamboo fiber is at least 0.4% by weight of the total gummy weight.

The gummy supplement of the present disclosure may also be coated with a high melting point wax, preferably carnauba wax. In other embodiments, beeswax could be utilized. The high melting point wax creates a shell around the gummy supplement that further inhibits sticking in combination with the bamboo fiber coating.

The present invention was developed with the intention that the gelling component in the gummy supplement is pectin. In other embodiments, gelatin, carrageenan gelatin, agar-agar, locust bean gum, carrageenan, starch or combinations thereof may be utilized.

According to another exemplary implementation of the present disclosure, a method of making gummy supplements is provided. The method includes the steps of hydrating a gelling component, mixing the hydrated gelling component with sugar and/or a sugar alternative and cooking the mixture, and adding an active ingredient, color, flavor, and acid to the mixture. The method further includes depositing the cooked mixture into a starchless forming structure to make formed gummy supplements, removing the formed gummy supplements from the forming structure, and applying a coating comprising bamboo fiber to the demolded gummy supplements to make coated gummy supplements. The method concludes by curing the coated gummy supplements to complete gelling and packing a plurality of the coated gummy supplements in a common container.

### BRIEF DESCRIPTION OF THE DRAWINGS

The present disclosure is described with reference to the following FIGURES.

FIG. 1 is a flow chart depicting an exemplary method of manufacturing a gummy supplement according to the present disclosure.

### DETAILED DESCRIPTION

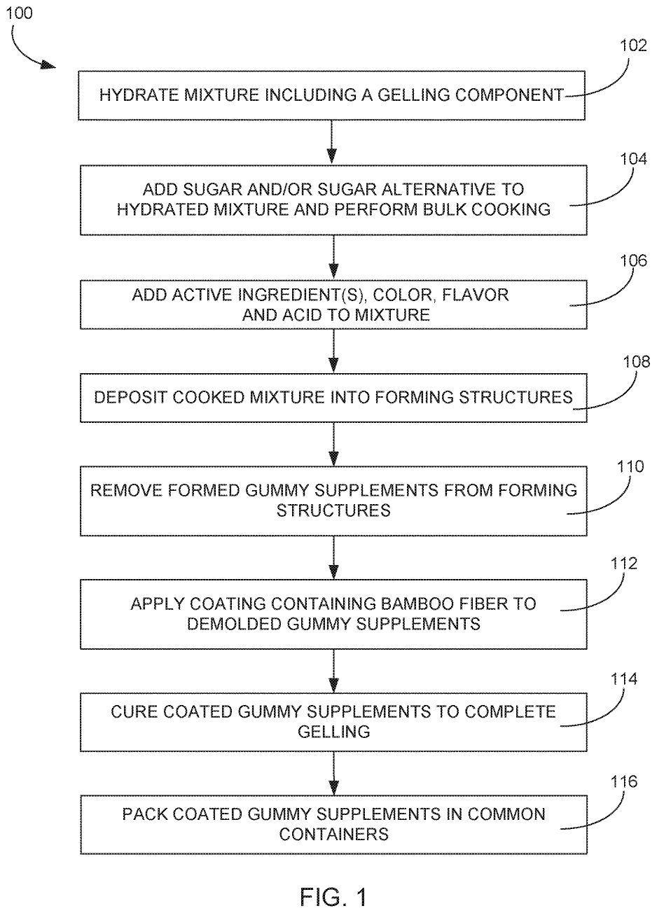

The present inventors have recognized that cellulose fiber, and particularly bamboo fiber, exhibits remarkable performance as an anti-sticking agent in a starchless manufacturing process for gummy supplements. In a preferred form of a powder extracted from the stem and leaves of a bamboo plant, bamboo fiber applied as a gummy supplement coating does not have a strong flavor or odor, and contains only a negligible amount of natural sugar. FIG. 1 illustrates the steps in an exemplary manufacturing method 100 for making improved gummy supplements, and more particularly gummy supplements having a bamboo fiber coating, in accordance with the invention. FIG. 1 is merely an exemplary method, and variations in the manufacturing method are contemplated within the scope of the invention.

First, at step 102, a mixture including a gelling component is hydrated with water to form a slurry. The ingredients of the mixture are generally in powdered form and include the gelling component, and one or more of sugar, sodium citrate, and citric acid. A full ingredient list of an exemplary gummy composition manufactured according to the present disclosure is included below in Table 4. In a preferred embodiment the gelling component is pectin. In other embodiments, the gelling component may be one or more of gelatin, agar-agar, carrageenan, or vegan gel (containing one or more ingredients such as carrageenen, tapioca dextrin, and vegetable gum). The gelling component or structurant utilized may determine the additional ingredients used to form the slurry. For example, if pectin is utilized, sodium citrate or citric acid may be used for pectin hydration depending on whether buffered pectin is utilized. If gelatin or agar-agar is utilized as the gelling component, only sugar may be added. In a large-scale gummy production line, step 102 may be performed using a weigh tank that is configured to measure each of the ingredients in the mixture and to deposit the ingredients within a mixer or cooker.

Continuing with step 104, sugar and/or sugar alternatives (e.g., inulin, soluble corn fiber, allulose, tapioca syrup) are added to the hydrated mixture formed at step 102. The mixture is cooked in a vessel to remove extraneous water from the mixture. In some embodiments, the ingredients may be transferred from the weigh tank into a cooker which uses a jacket of hot pressurized steam running between an inner and outer layer to heat the gummy slurry mixture.

At step 106, one or more active ingredients, colors, flavors, and acid ingredients are added to the mixture formed at step 104. In various implementations, the one or more active ingredients are contemplated to include a vitamin composition, a mineral composition, an organic acid composition (e.g., apple cider vinegar), an amino acid composition (e.g., leucine), an antioxidant composition, an herbal composition (e.g., elderberry), a probiotic and/or postbiotic composition, and an active pharmaceutical ingredient (API) composition (e.g., melatonin).

Method 100 continues with step 108 as a hopper system deposits the cooked mixture formed at step 108 into forming structures (e.g., molds). In a preferred embodiment, prior to deposit of the gummies in the molds, the concentration of dissolved sugar in the gummy slurry is measured in units Brix (° Bx), where 1° Bx is equivalent to 1 g of sugar in 100 g of solution (i.e., 1% sugar by weight). The sugar concentration may be measured using a Brix refractometer. The present inventors have determined that in preferred embodiments, the gummy slurry prior to deposit is in the range of 77 to 80° Bx to achieve proper water content in the finished gummy product.

In some embodiments, step 108 is performed using a depositor. The depositor may include a depositing head and a mold circuit. The cooked mixture formed through step 106 is held in a heated hopper fitted with multiple pump cylinders, and the mixture is drawn through the pump cylinders and ejected into molds. As provided above, in a starchless manufacturing process, the molds are generally fabricated from silicone, rubber, metal, or polycarbonate. The molds may further include a non-stick coating, such as Teflon. In preferred embodiments, the molds are fabricated from aluminum coated with Teflon. The molds may include cavities to form the gummies in a variety of smooth or irregularly contoured shapes and in a range of weights. In a preferred embodiment, the cavities are generally gumdrop or raspberry-shaped, but the shape of the cavities is not particularly limited, and any desired cavity shape may be utilized with the gummy coating methods disclosed herein.

The molds may further be lubricated with an oil to prevent sticking of the formed gummy supplements to the molds. In a preferred embodiment, medium chain triglyceride (MCT) oil may be sprayed into the cavities of the molds before the cooked mixture is deposited into the molds. In other embodiments, a different oil (e.g., coconut oil) or a combination of oil and lecithin or carnauba wax could be utilized for mold lubrication.

Method 100 continues at step 110 as the formed gummies are removed from the forming structures, for example, through the use of spring-loaded mold ejector mechanisms. In some embodiments, the formed gummies are removed within cooling tunnel equipment.

At step 112, a coating containing bamboo fiber is applied to the demolded gummy supplements. In a preferred embodiment, the bamboo fiber is pure bamboo fiber in powdered form, although in other embodiments, the bamboo fiber could be mixed with another suitable coating (e.g., silica, citrus fiber, tapioca starch). The present inventors have determined through testing that bamboo fiber powder having an average particle size of approximately 40 microns results in uniform application to the gummy surfaces. Tests utilizing bamboo fiber powder having a larger average particle size (e.g., 90 microns) resulted in non-uniform adhesion to the gummy surfaces. In a preferred embodiment, the bamboo fiber may be applied to the demolded gummies using coating drum or tumbler equipment. For example, in one preferred embodiment, the bamboo fiber is applied to gummies within tumbler equipment using automated or manual means at a rate in the range of 3.0-5.0 Kg/hour. In other embodiments, the bamboo fiber may be applied to the gummies using a dusting machine or by hand, for example, by placing the gummies in a bag or bowl and then shaking or mixing the bamboo fiber onto the gummies until the bamboo fiber is visually uniform on the gummy surface.

At step 114, the coated gummy supplements are cured at an elevated temperature to complete the gelling process. In a preferred embodiment, the coated gummies may be cured for several days (e.g., 65 hours) to permit the gummy structure to completely develop. As described above, the present inventors have determined that in preferred embodiments, the gummy slurry prior to deposit is in the range of 77 to 80° Bx to achieve proper water content in the finished gummy product. The water content of the gummies during curing may be measured and correlated with desired hardness values using a handheld humidity meter initially 24 hours after commencement of the curing process, and every 12 hours thereafter.

In certain embodiments, a secondary coating of bamboo fiber and/or a high melting point wax that is solid at room temperature may be applied to the gummies after the curing process is completed. In a preferred embodiment, the high melting point wax may be carnauba wax that is solid at room temperature. An exemplary recipe for a secondary coating containing carnauba wax in a vegetable oil carrier is included below in Table 6. In other embodiments, a different high melting point wax, such as beeswax may be utilized. The high melting point wax may be dissolved in an oil, for example, MCT oil, and sprayed onto the cured gummies. The inventors have recognized that by first coating the gummies with the bamboo fiber, the bamboo fiber provides an outer structure to the gummy slurry surface that is able to retain the wax particles when they are sprayed onto the gummies so that a non-sticky outer shell that resists deformation is formed.

Method 100 concludes at step 116, as the gummy supplements are packaged into containers. The type and size of container is not particularly limited, and in various embodiments, may be a bottle, jar, bag, sachet, or pouch. The material composition of the container is similarly not limited, and in various embodiments may be plastic, glass, or mylar.

The inventors have performed multiple tests to verify the suitability of bamboo fiber for gummy supplement coating purposes, and to verify an optimal range for the amount of bamboo fiber to be used as a coating for the gummy supplements. Table 1 below presents the results of a test conducted on five groups of apple cider vinegar gummy supplements formed in the raspberry shape. Samples were removed from a production line (see block 110 of FIG. 1) and coated by hand with various amounts of powdered bamboo fiber ranging from 0.20% to 0.60% of the total weight of the gummy. The coated samples were then permitted to cure at an elevated temperature (e.g., 30° C.) for 65 hours. At the end of the curing period, each of the groups was packaged into a 300 cm³ bottle, capped, and stored upside down at room temperature for six weeks.

After six weeks, the properties of the gummies within the bottles were observed. Regarding surface appearance, the gummy samples ranged from having a wet and oily appearance when the bamboo fiber was applied in a smaller amount (0.20% by weight) and a dry appearance when the bamboo fiber was applied in a larger amount (0.60% by weight). White particles were not present when the bamboo fiber was applied in amount of less than 0.40% by weight. All of the gummies in all of the samples were stuck together after six weeks, but strong hand shaking unstuck a range from a small percentage of the gummies when the bamboo fiber was applied in a smaller amount (0.20% by weight) to a large percentage of the gummies when the bamboo fiber was applied in a larger amount (0.40% by weight or greater).

TABLE 1

| | | White | | After strong |
|---|---|---|---|---|
| | | particles | | hand shaking, |
| Coating | Surface | present on | Stuck | how much (%) |
| Wt % | appearance | surface? | together? | loosened |
| 0.20% | wet and oily | no | All stuck | 5 |
| 0.30% | slightly wet | no | together | 20 |
| | and oily | | | |
| 0.40% | dry and | no | | 75 |
| | slightly oily | | | |
| 0.50% | dry | small amount | | 85 |
| 0.60% | dry | medium amount | | 95 |

Table 2 below presents the results of another test conducted on four groups of raspberry-shaped elderberry gummy supplements. The first group was coated in powdered bamboo fiber at room temperature in an amount of 0.28% by weight. The second group was coated in powdered bamboo fiber at room temperature in an amount of 0.33% by weight. The third group was a control group in which the elderberry gummy supplements were coated in powdered tapioca starch at room temperature in an amount of 0.50% by weight. The fourth group was also a control group in which the elderberry gummy supplements were coated in powdered tapioca starch at room temperature in an amount of 0.65% by weight. Each of the groups was then packaged in a 120 cm³ bottle, capped, and stored at room temperature for eight weeks.

As shown, after two weeks at room temperature, the gummies in each of the four groups were able to be loosened from sticking to each other and/or the bottle. Both the first and second bamboo fiber groups required only gentle hand shaking to unstick 100% of the gummies from the bottle surfaces and each other, while both of the tapioca starch control groups required strong hand shaking to unstick 100% of the gummies from the bottle surfaces and each other. After three weeks, both the first and second bamboo fiber groups required strong hand shaking to unstick 100% of the gummies from the bottle surfaces and each other, while the same intensity of hand shaking only managed to unstick about 25% of the gummies in the tapioca starch control groups. At four weeks, the status of the first and second bamboo fiber groups was unchanged from week three, while none of the gummies in the tapioca starch control groups were unstuck after strong hand shaking.

At six weeks, both of the first and second bamboo fiber groups required strong hand shaking to unstick 50% of the gummies from the bottle surfaces and each other. None of the gummies in the tapioca starch control groups were unstuck after strong hand shaking. Finally, at eight weeks, strong hand shaking was not able to unstick any of the gummies in any of the bamboo fiber and tapioca starch control groups. Accordingly, the test revealed that the bamboo fiber performed significantly better as a coating than tapioca starch, even though a smaller amount by weight of bamboo fiber was applied to the gummies than the tapioca starch.

TABLE 2

| | 0.28 wt. % | 0.33 wt. % | 0.50 wt. % | 0.65 wt. % |
|---|---|---|---|---|
| Weeks | Bamboo Fiber | Bamboo Fiber | Tapioca Starch | Tapioca Starch |
| 2 | 100% loosened after | 100% loosened after | 100% loosened after | 100% loosened after |
| | gentle shaking | gentle shaking | strong shaking | strong shaking |
| 3 | 100% loosened after | 100% loosened after | 25% loosened after | 25% loosened after |
| | strong shaking | strong shaking | strong shaking | strong shaking |
| 4 | 100% loosened after | 100% loosened after | 0% loosened after | 0% loosened after |
| | strong shaking | strong shaking | strong shaking | strong shaking |
| 6 | 50% loosened after | 50% loosened after | 0% loosened after | 0% loosened after |
| | strong shaking | strong shaking | strong shaking | strong shaking |
| 8 | 0% loosened after | 0% loosened after | 0% loosened after | 0% loosened after |
| | strong shaking | strong shaking | strong shaking | strong shaking |

Table 3 below presents the results of yet another test conducted on three groups of elderberry gummy supplements formed in the raspberry shape. The first group was coated in powdered bamboo fiber at room temperature in an amount of 0.30% by weight. The second group was coated in powdered bamboo fiber at room temperature in an amount of 0.60% by weight. A control group was coated with tapioca starch and compared to the bamboo fiber-coated groups. Each of the groups was packaged in an 840 cm³ bottle, capped, and stored upside down at room temperature for three weeks.

The groups were monitored weekly, both before and after hand shaking was performed. “Hand shaking” as implemented in this test consisted of shaking the bottle in an upright position five times back and forth and rotating the bottle after shaking to observe how many gummies have become loose from the cluster after shaking. As shown, the two bamboo fiber-coated groups performed significantly better than the tapioca starch control group, as after three weeks and before and after shaking, the majority of the bamboo-fiber coated gummies were not sticking to each other or the bottle surfaces. By contrast, a majority of the gummies in the control groups began sticking after week one, although a majority of the tapioca starch-coated gummies could subsequently be unstuck after shaking. Again, the test revealed that bamboo fiber performed significantly better than a comparable coating for gummies comprising tapioca starch.

TABLE 3

| | 0.30 wt. % | 0.60 wt. % | Control: |
|---|---|---|---|
| Weeks | Bamboo Fiber | Bamboo Fiber | Tapioca Starch |
| 0 | Didn't stick | Didn't stick together. | All gummies stuck together; |
| | together. | | one gummy stuck on the |
| | | | bottom. |
| 0 | Didn't stick | Didn't stick together. | Didn't stick together. |
| (After | together. | | |
| Shaking) | | | |
| 1 | About 10% | About 5% gummies stuck | About 50% gummies stuck |
| | gummies stuck | together; 5 gummies on the | together; 5 gummies stuck on |
| | together; 6 gummies | bottom, 3 gummies on the | the bottom; 8 on the wall. |
| | on the bottom, 6 | wall. | |
| | gummies on the | | |
| | wall. | | |
| 1 | Gummies didn't | Gummies didn't stick together; | About 10% gummies stuck |
| (After | stick together; only | 6 gummies stuck on the | together; 2 gummies stuck on |
| Shaking) | 6 gummies stuck on | bottom and 3 gummies on the | the bottom. |
| | the wall. | wall. | |
| 2 | About 10% | About 5% gummies stuck | About 50% gummies stuck |
| | gummies stuck | together; 3 gummies on the | together; 6 gummies stuck on |
| | together; 6 gummies | bottom, 5 gummies on the | the bottom; 9 on the wall. |
| | on the bottom, 6 | wall. | |
| | gummies on the | | |
| | wall. | | |
| 2 | Gummies didn't | Gummies didn't stick together; | About 10% gummies stuck |
| (After | stick together; 3 | 3 gummies stuck on the | together; 6 gummies stuck on |
| Shaking) | gummies stuck on | bottom and 3 gummies on the | the bottom; 9 on the wall. |
| | the bottom; 5 on the | wall. | |
| | wall. | | |
| 3 | About 30% | About 10% gummies stuck | About 50% gummies stuck |
| | gummies stuck | together; 2 on the bottom; 5 on | together; 5 gummies stuck on |
| | together; 3 gummies | the wall. | the bottom; 7 on the wall. |
| | on the bottom; 4 on | | |
| | the wall. | | |
| 3 | About 5% gummies | Gummies didn't stick together; | About 10% gummies stuck |
| (After | stuck together; 3 on | 2 on the bottom and 5 on the | together; 5 gummies stuck on |
| Shaking) | the bottom and 4 on | wall. | the bottom; 7 on the wall. |
| | the wall. | | |

Table 4 below presents the results of yet another test conducted on a group of elderberry gummy supplements formed in the raspberry shape. The group was first coated in powdered bamboo fiber at room temperature in an amount of 0.5% by weight, and then with a wax coating in an amount of 0.1% by weight. The wax coating contained carnauba wax in an amount by weight of 5-15% in a carrier of vegetable oil (see exemplary recipe in Table 6 below).

The group was monitored for a total of twelve weeks: weekly through the first four weeks, and subsequently at six, eight and twelve weeks. Tests were performed both before hand shaking, in which the bottle was inverted from an upright position and observed, and after hand shaking was performed. “Hand shaking” as implemented in this test consisted of shaking the bottle in an upright position five times back and forth and rotating the bottle after shaking to observe how many gummies have become loose from the cluster after shaking. As shown, the combination of bamboo fiber and wax coatings exhibited superior results as compared with similar amounts of bamboo fiber coating alone.

TABLE 4

| Weeks | Upside Down Test Results | Hand Shaking Test Results |
|---|---|---|
| 0 | Didn't stick together. | Didn't stick together. |
| 1 | Didn't stick together. | Didn't stick together. |
| 2 | Didn't stick together, 3 | Didn't stick together. |
| | gummies stuck on walls | |
| 3 | Didn't stick together, 2 | Didn't stick together. |
| | gummies stuck on walls | |
| 4 | Didn't stick together, 4 | Didn't stick together. |
| | gummies stuck on walls, 1 | |
| | gummy stuck on bottom | |
| 6 | Didn't stick together, 2 | Didn't stick together. |
| | gummies stuck on walls | |
| 8 | Didn't stick together, 4 | Didn't stick together. |
| | gummies stuck on walls | |
| 12 | Didn't stick together, 6 | Didn't stick together. |
| | gummies stuck on walls | |

Table 5 below depicts an exemplary recipe for an elderberry gummy supplement that may be manufactured according to the present disclosure prior to the application of the coating comprising bamboo fibers. The “Wt. % range” column provides a typical acceptable range for each component, and the “Example Wt. %” column provides the measured amounts of each ingredient in an exemplary batch of elderberry gummy supplements. The below ingredient list is merely exemplary, and additions, deletions, and deviations from the list as well as the ranges provided are contemplated within the scope of the present invention.

TABLE 5

| Ingredient | Wt. % range | Example Wt. % |
|---|---|---|
| WATER | 8.0-12.0% | 10.571% |
| PECTIN | 2.4-3.2% | 2.850% |
| TAPIOCA SYRUP | 35.0-42.0% | 40.532% |
| SUGAR | 35.0-42.0% | 40.300% |
| ELDERBERRY EXTRACT | 0.5-1.5% | 0.900% |
| VITAMIN D3 | 0.1-0.5% | 0.281% |
| ASCORBIC ACID | 0.5-3.2% | 2.557% |
| VITAMIN PALMITATE | 0.05-0.2% | 0.064% |
| SODIUM CITRATE | 0.2-0.8% | 0.405% |
| ZINC CITRATE | 0.2-0.8% | 0.400% |
| NAT MIXED BERRY FLAVOR | 0.5-1.1% | 0.850% |
| CITRIC ACID ANHYDROUS | 0.1-0.8% | 0.290% |
| | Total: | 100.000% |

Table 6 below depicts an exemplary recipe for a wax coating that may be applied to gummy supplements according to the present disclosure. As described above, in some implementations, the wax coating may be applied following the application of the bamboo fiber coating. In further implementations, an additional bamboo fiber coating layer may be applied following the application of the wax coating layer. The “Wt. % range” column provides a typical acceptable range for each component, and the “Function” column provides a purpose of each ingredient in the coating mixture. The below ingredient list is merely exemplary, and additions, deletions, and deviations from the list as well as the ranges provided are contemplated within the scope of the present invention.

TABLE 6

| | Wt. % | |
|---|---|---|
| Ingredient | range | Function |
| VEGETABLE OIL | 80.0-95.0% | CARRIER |
| (NON-HYDROGENATED) | | |
| CARNAUBA WAX (E 903) | 5.0-15.0% | GLAZING AGENT |
| TOCOPHEROL-RICH | <0.1% | ANTIOXIDANT |
| EXTRACT (E 306) | | |
| CITRIC ACID (E 330) | <0.1% | SEQUESTRANT |

What is claimed is:

1. A gummy supplement, comprising:
a mixture of sugar and/or a sugar alternative, a gelling component, an active component, color, flavor, and acid, wherein the amount of the gelling component is sufficient to result in a formed gelled product after the mixture is cooked and cured; and
a coating for the formed gelled product comprising bamboo fiber.

2. The gummy supplement of claim 1, wherein the bamboo fiber ranges from 0.2 to 1.5% by weight.

3. The gummy supplement of claim 1, wherein the bamboo fiber is at least 0.4% by weight.

4. The gummy supplement of claim 1, wherein the gelling component comprises at least one of pectin, gelatin, agar-agar, locust bean gum, starch, and carrageenan.

5. The gummy supplement of claim 1, wherein the coating further comprises wax.

6. The gummy supplement of claim 5, wherein the wax is carnauba wax.

7. The gummy supplement of claim 1, wherein the formed gelled product is generally gumdrop-shaped or has smooth outer contours.

8. The gummy supplement of claim 1, wherein the formed gelled product is generally raspberry-shaped or has at least partially irregular outer contours.

9. The gummy supplement of claim 1, wherein the bamboo fiber is in powdered form.

10. The gummy supplement of claim 1, wherein the active component comprises at least one of a vitamin composition, a mineral composition, an organic acid composition, an amino acid composition, an antioxidant composition, an herbal composition, a probiotic and/or postbiotic composition, and an active pharmaceutical ingredient (API) composition.

11. A method of making gummy supplements, comprising the steps of:
hydrating a gelling component;
mixing the hydrated gelling component with sugar and/or a sugar alternative and cooking the mixture;
adding an active ingredient, color, flavor, and acid to the mixture;
depositing the cooked mixture into a starchless forming structure to make formed gummy supplements;
removing the formed gummy supplements from the forming structure;
applying a coating comprising bamboo fiber to the demolded gummy supplements to make coated gummy supplements;
curing the coated gummy supplements to complete gelling; and
packing a plurality of the coated gummy supplements in a common container.

12. The method of claim 11, wherein the bamboo fiber ranges from 0.2 to 1.5% by weight.

13. The method of claim 11, wherein the bamboo fiber is at least 0.4% by weight.

14. The method of claim 11, wherein the gelling component comprises at least one of pectin, gelatin, agar-agar, and carrageenan.

15. The method of claim 11, wherein the method further comprises applying a wax to the coated gummy supplements responsive to completion of the curing step.

16. The method of claim 15, wherein the wax is carnauba wax.

17. The method of claim 11, wherein the forming structure is a mold configured to make generally gumdrop-shaped or generally raspberry-shaped formed gelled product.

18. The method of claim 11, wherein the bamboo fiber is in powdered form.

19. The method of claim 11, further comprising applying a second coating comprising bamboo fibers responsive to completion of the curing step.

20. The method of claim 11, wherein the bamboo fiber has an average particle size of approximately 40 microns.

21. The method of claim 11, wherein the coating further comprises silica.
